(19) United States
(12) Patent Application Publication
(10) Pub. No.: US 2025/0328099 A1
(43) Pub. Date: Oct. 23, 2025

(54) IMAGE FORMING APPARATUS, IMAGE FORMING METHOD

(71) Applicant: KYOCERA Document Solutions Inc., Osaka (JP)

(72) Inventors: Masaru Watanabe, Osaka (JP); Makoto Matsumoto, Osaka (JP); Yasuaki Sakamoto, Osaka (JP); Ayato Morikami, Osaka (JP); Yukiko Kotani, Osaka (JP); Atsuki Ito, Osaka (JP)

(21) Appl. No.: 19/180,849

(22) Filed: Apr. 16, 2025

(30) Foreign Application Priority Data
Apr. 19, 2024 (JP) 2024-068142

(51) Int. Cl. G03G 15/00; G03G 15/23

(52) U.S. Cl. CPC G03G 15/5058; G03G 15/234

(57) ABSTRACT

An image forming apparatus includes a first image processing portion and a second image processing portion. In a double-sided printing process that forms a print image on a front side and a back side of a sheet, the first image processing portion executes a print image forming process corresponding to the front side and the print image forming process corresponding to the back side under different image forming conditions. In a case in which a detection image forming process is executed during execution of the double-sided printing process, the second image processing portion executes the detection image forming process only under the image forming conditions in the print image forming process corresponding to a predetermined one of the front side and the back side.

### INCORPORATION BY REFERENCE

This application is based upon and claims the benefit of priority from the corresponding Japanese Patent Application No. 2024-068142 filed on Apr. 19, 2024, the entire contents of which are incorporated herein by reference.

The present disclosure relates to an image forming apparatus and an image forming method.

### BACKGROUND

An electrophotographic image forming apparatus includes an image forming portion that forms an image on a sheet based on input image data. In the image forming apparatus, a print image forming process is executed in which a print image based on the image data is formed on a transfer medium such as an intermediate transfer belt by an image forming portion. Furthermore, in the image forming apparatus, during the execution of the print image forming process, a detection image forming process may be executed to form a detection toner image used for adjusting an image forming condition in the image forming portion.

### SUMMARY

An image forming apparatus according to one aspect of the present disclosure includes an image forming portion, a first image processing portion, and a second image processing portion. The image forming portion forms an image based on input image data on a transfer medium, and transfers the image from the transfer medium to a sheet. The first image processing portion executes a print image forming process in which the image forming portion forms a print image in a predetermined printing area on the transfer medium based on image data of a printing target. When a preset execution condition is satisfied, the second image processing portion executes a detection image forming process in which a detection image used for adjusting an image forming condition in the image forming portion is formed in an area outside the printing area on the transfer medium by the image forming portion. In a double-sided printing process that forms the print image on a front side and a back side of a sheet, the first image processing portion executes the print image forming process corresponding to the front side and the print image forming process corresponding to the back side under different image forming conditions. In a case in which the detection image forming process is executed during execution of the double-sided printing process, the second image processing portion executes the detection image forming process only under the image forming condition in the print image forming process corresponding to a predetermined one of the front side and the back side.

An image forming method according to another aspect of the present disclosure is a method executed by a processor of an image forming apparatus having an image forming portion that forms an image on a transfer medium based on input image data and transfers the image from the transfer medium to a sheet. In the image forming method, a first step and a second step are executed. The first step executes a print image forming process in which the image forming portion forms a print image in a predetermined printing area on the transfer medium based on image data of a printing target. The second step of, when a preset execution condition is satisfied, executes a detection image forming process in which a detection image used for adjusting an image forming condition in the image forming portion is formed in an area outside the printing area on the transfer medium by the image forming portion In a double-sided printing process that forms the print image on a front side and a back side of a sheet, the first step executes the print image forming process corresponding to the front side and the print image forming process corresponding to the back side under different image forming conditions. In a case in which the detection image forming process is executed during execution of the double-sided printing process, the second step executes the detection image forming process only under the image forming condition in the print image forming process corresponding to a predetermined one of the front side and the back side.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus of an embodiment according to the present disclosure.

FIG. 2 is a block diagram showing a system configuration of an image forming apparatus of an embodiment according to the present disclosure.

FIG. 3 is a schematic diagram showing a configuration of an image forming portion of an image forming apparatus of an embodiment according to the present disclosure.

FIG. 4 is a schematic diagram showing a configuration of an intermediate transfer belt of an image forming apparatus of an embodiment according to the present disclosure.

FIG. 5 is a flowchart showing an example of a printing control process executed by an image forming apparatus of an embodiment according to the present disclosure.

FIG. 6 is a flowchart showing an example of an adjustment control process executed in an image forming apparatus of an embodiment according to the present disclosure.

FIG. 7 is a diagram schematically showing an example of a detection toner image formed on an intermediate transfer belt in an image forming apparatus of an embodiment according to the present disclosure.

FIG. 8 is a flowchart showing another example of an adjustment control process executed in an image forming apparatus of an embodiment according to the present disclosure.

FIG. 9 is a diagram schematically showing an example of a detection toner image formed on an intermediate transfer belt in an image forming apparatus of an embodiment according to the present disclosure.

### DETAILED DESCRIPTION

Hereinafter, embodiments of a technique according to the present disclosure will be described with reference to the accompanying drawings. Note that the following embodiments are examples of the technique according to the present disclosure and do not limit the technical scope of the present disclosure.

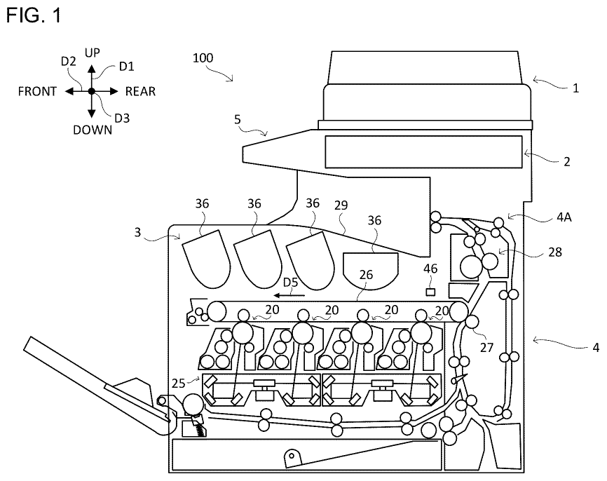

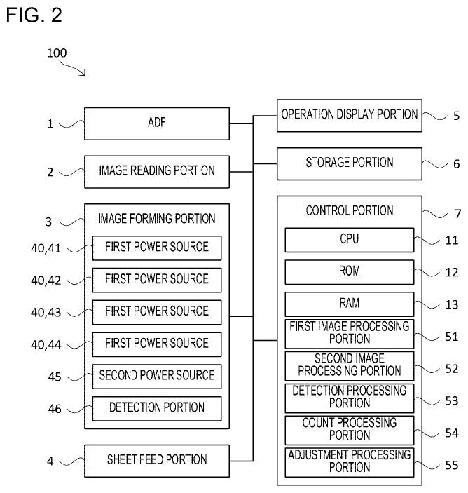

First, a configuration of an image forming apparatus 100 of an embodiment according to the present disclosure will be described with reference to FIGS. 1 and 2.

Note that for ease of explanation, a vertical direction in an installed state in which the image forming apparatus 100 is usable (state shown in FIG. 1) is defined as an up-down direction D1. In addition, a front-rear direction D2 is defined with the left side of the paper surface of the image forming apparatus 100 shown in FIG. 1 as the front surface (front side). Further, a left-right direction D3 is defined based on the front surface of the image forming apparatus 100 in the installed state.

The image forming apparatus 100 is a multifunction peripheral having multiple functions, such as a scanning function for reading an image of an original document, a printing function for forming an image based on image data, a fax function, and a copy function. Note that the technique according to the present disclosure may be applied to image forming apparatuses such as printers, fax machines, and copy machines that are capable of forming images by an electrophotographic method.

As shown in FIGS. 1 and 2, an image forming apparatus 100 includes an auto document feeder (ADF) 1, an image reading portion 2, an image forming portion 3, a sheet feed portion 4, an operation display portion 5, a storage portion 6, and a control portion 7.

The ADF 1 conveys an original document to be read by the scanning function. The ADF 1 includes a document setting portion, a plurality of conveying rollers, a document holder, and a sheet discharge portion.

The image reading portion 2 implements the scanning function. The image reading portion 2 includes a document table, a light source, a plurality of mirrors, an optical lens, and a charge coupled device (CCD).

The image forming portion 3 implements the printing function. More specifically, the image forming portion 3 forms a color or monochrome image based on input image data on a sheet supplied from the sheet feed portion 4 by an electrophotographic method.

The sheet feed portion 4 supplies sheets to the image forming portion 3. The sheet feed portion 4 includes a sheet feed cassette, a manual feed tray, and a plurality of conveying rollers. The sheet feed portion 4 also includes a double-sided printing mechanism 4A that turns over front and back sides of the sheet on which an image has been formed by the image forming portion 3 and conveys the sheet again to the image forming portion 3. Thus, it is possible for the image forming apparatus 100 to execute a double-sided printing operation in which images are formed on both the front and back sides of a sheet by the image forming portion 3.

The operation display portion 5 is a user interface of the image forming apparatus 100. The operation display portion 5 has a display portion such as a liquid crystal display that displays various types of information in response to control instructions from the control portion 7, and an operation portion such as operation keys or a touch panel that inputs various types of information to the control portion 7 in response to user operations.

The storage portion 6 is a non-volatile storage device. For example, the storage portion 6 is a non-volatile memory such as a flash memory. Note that the storage portion 6 may be a solid state drive (SSD) or a hard disk drive (HDD).

The control portion 7 performs overall control of the image forming apparatus 100. As shown in FIG. 2, the control portion 7 includes a CPU 11, a ROM 12, and a RAM 13. The CPU 11 includes one or more processors that execute various types of arithmetic processing. The ROM 12 is a non-volatile storage device in which information such as control programs for causing the CPU 11 to execute various types of processes is stored in advance. The RAM 13 is a volatile or non-volatile storage device used as a temporary storage memory (work area) for various types of processes executed by the CPU 11. The CPU 11 performs overall control of the image forming apparatus 100 by executing various types of control programs stored in advance in the ROM 12.

Note that the control portion 7 may be a control portion provided separately from a main control portion that performs overall control of the image forming apparatus 100. In addition, the control portion 7 may also be configured with an electronic circuit such as an integrated circuit (ASIC).

### Configuration of Image Forming Portion 3

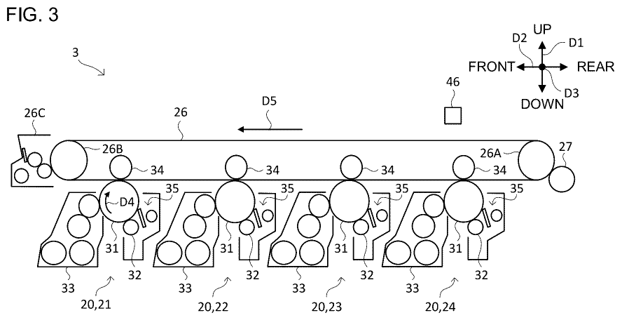

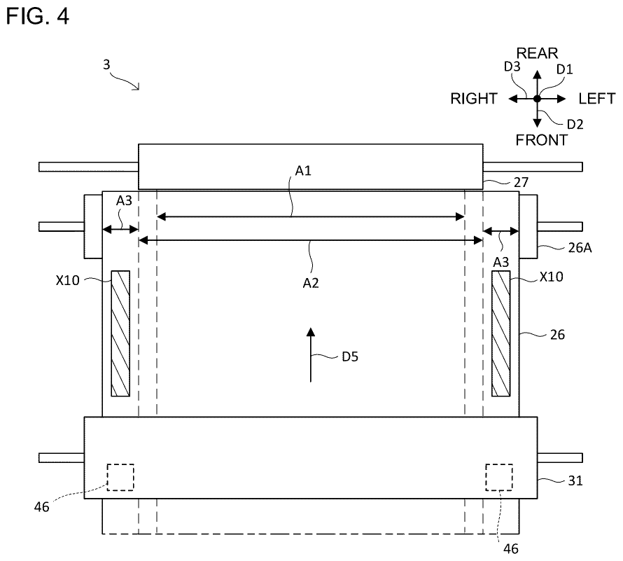

Next, a configuration of the image forming portion 3 will be described with reference to FIGS. 1 to 4. Here, FIG. 3 is a schematic diagram showing the configuration of a plurality of image forming units 20, an intermediate transfer belt 26, and a secondary transfer roller 27. In addition, FIG. 4 is a schematic diagram showing configuration of the photoconductor drum 31, the intermediate transfer belt 26, a drive roller 26A, and the secondary transfer roller 27 of the image forming unit 24

As shown in FIG. 1, the image forming portion 3 includes four image forming units 20, a laser scanning unit 25, an intermediate transfer belt 26, a secondary transfer roller 27, a fixing device 28, and a sheet discharge tray 29. In addition, as shown in FIGS. 2 and 3, the image forming portion 3 includes four first power sources 40, a second power source 45, and a detection portion 46. The image forming portion 3 forms a toner image on the intermediate transfer belt 26 based on input image data, and transfers the toner image from the intermediate transfer belt 26 onto a sheet.

The four image forming units 20 include image forming units 21 to 24. The image forming unit 21 (see FIG. 3) forms a yellow (Y) toner image. The image forming unit 22 (see FIG. 3) forms a cyan (C) toner image. The image forming unit 23 (see FIG. 3) forms a magenta (M) toner image. The image forming unit 24 (see FIG. 3) forms a black (K) toner image.

As shown in FIG. 3, each image forming unit 20 includes a photoconductor drum 31, a charging roller 32, a developing device 33, a primary transfer roller 34, and a drum cleaning portion 35. In addition, each of the image forming units 20 also includes a toner container 36 shown in FIG. 1.

An electrostatic latent image is formed on a surface of the photoconductor drum 31. For example, the photoconductor drum 31 has a photosensitive layer made of amorphous silicon. The photoconductor drum 31 receives a rotational driving force supplied from a motor (not shown) and rotates in a drum rotation direction D4 shown in FIG. 3. Thus, the photoconductor drum 31 conveys the electrostatic latent image formed on the surface.

The charging roller 32 is applied with a preset charging voltage to charge the surface of the photoconductor drum 31. For example, the charging roller 32 charges the surface of the photoconductor drum 31 to a positive polarity. The surface of the photoconductor drum 31 charged by the charging roller 32 is irradiated with light based on image data emitted from the laser scanning unit 25. Thus, an electrostatic latent image is formed on the surface of the photoconductor drum 31.

The developing device 33 develops the electrostatic latent image formed on the surface of the photoconductor drum 31. The developing device 33 includes a pair of stirring members, a magnet roller, and a developing roller. The pair of stirring members stir a developing agent that includes a toner and a carrier and is accommodated inside the developing device 33. For example, the toner included in the developing agent is positively charged due to friction with the carrier included in the developing agent. The magnet roller picks up the developing agent stirred by the pair of stirring members, and supplies the toner included in the developing agent to the developing roller. The developing roller conveys the toner supplied from the magnet roller to a position facing the photoconductor drum 31. In addition, the developing roller is applied with a preset developing bias voltage and supplies the toner conveyed to an opposing position to the photoconductor drum 31. Thus, toner is selectively supplied to an exposure area of the photoconductor drum 31 irradiated with light emitted from the laser scanning unit 25, and the electrostatic latent image formed on the surface of the photoconductor drum 31 is developed. Note that the developing device 33 is supplied with toner from a toner container 36.

The primary transfer roller 34 is supplied with a preset primary transfer current, and transfers the toner image formed on the surface of the photoconductor drum 31 onto the outer peripheral surface of the intermediate transfer belt 26. As shown in FIG. 3, the primary transfer roller 34 is provided opposite the photoconductor drum 31 with the intermediate transfer belt 26 arranged therebetween. Note that the intermediate transfer belt 26 is an example of a transfer medium in the present disclosure.

The drum cleaning portion 35 removes the toner remaining on the surface of the photoconductor drum 31 after the toner image has been transferred by the primary transfer roller 34.

The laser scanning unit 25 emits light based on image data toward the surface of the photoconductor drum 31 of each image forming unit 20.

The intermediate transfer belt 26 is an endless belt member onto which the toner images formed on the surfaces of the photoconductor drums 31 of the image forming units 20 are transferred. For example, the intermediate transfer belt 26 is made of a resin material such as polyimide. The intermediate transfer belt 26 is stretched with a predetermined tension by a drive roller 26A (see FIG. 3) and a tension roller 26B (see FIG. 3). The intermediate transfer belt 26 rotates in a belt rotation direction D5 shown in FIG. 3 as the driving roller 26A rotates upon receiving a rotational driving force supplied from a motor (not shown). Thus, the intermediate transfer belt 26 conveys the toner images transferred from the respective photoconductor drums 31 to a transfer position onto a sheet by the secondary transfer roller 27. Note that after the toner image is transferred by the secondary transfer roller 27, the outer peripheral surface of the intermediate transfer belt 26 is cleaned by a belt cleaning portion 26C (see FIG. 3).

The secondary transfer roller 27 is supplied with a preset secondary transfer current, and transfers the toner image transferred onto the outer peripheral surface of the intermediate transfer belt 26 onto a sheet supplied from the sheet feed portion 4. As shown in FIG. 3, the secondary transfer roller 27 is provided opposite the drive roller 26A with the intermediate transfer belt 26 arranged therebetween.

As shown in FIG. 4, a size of the secondary transfer roller 27 in the axial direction (size in the left-right direction D3) is smaller than a width of the intermediate transfer belt 26 (size in the left-right direction D3). Therefore, non-contact areas A3 (see FIG. 4) that do not come into contact with the secondary transfer roller 27 occur on the outer peripheral surface of the intermediate transfer belt 26. The non-contact areas A3 are areas on the outer peripheral surface of the intermediate transfer belt 26 outside a contact area A2 (see FIG. 4) that contacts the secondary transfer roller 27, and includes ends of the intermediate transfer belt 26 in the width direction.

The fixing device 28 fixes the toner image transferred onto the sheet by the secondary transfer roller 27 onto the sheet.

The sheet on which the toner image has been fixed by the fixing device 28 is discharged to the sheet discharge tray 29.

Of the four first power sources 40, a first power source 41 (see FIG. 2) is a constant current power source that supplies the primary transfer current to the primary transfer roller 34 of the image forming unit 21. Of the four first power sources 40, a first power source 42 (see FIG. 2) is a constant current power source that supplies the primary transfer current to the primary transfer roller 34 of the image forming unit 22. Of the four first power sources 40, a first power source 43 (see FIG. 2) is a constant current power source that supplies the primary transfer current to the primary transfer roller 34 of the image forming unit 23. Of the four first power sources 40, a first power source 44 (see FIG. 2) is a constant current power source that supplies the primary transfer current to the primary transfer roller 34 of the image forming unit 24. Each of the first power sources 40 supplies the primary transfer current set by the control portion 7 to the primary transfer roller 34. For example, the primary transfer current is a current with negative polarity.

The second power source 45 is a constant current power source that supplies the secondary transfer current to the secondary transfer roller 27. The second power source 45 supplies the secondary transfer current set by the control portion 7 to the secondary transfer roller 27. For example, the secondary transfer current is a current of negative polarity.

Detection portions 46 are provided at positions facing the non-contact areas A3 (see FIG. 4) on both ends of the outer peripheral surface of the intermediate transfer belt 26. The two detection portions 46 are used to detect the density and position of the toner image transferred to the non-contact areas A3. In the present embodiment, the two detection portions 46 are used to detect density and position of detection toner images X10 (described later) formed in the non-contact areas A3.

For example, the detection unit 46 is a reflective photosensor that has a light emitting portion that emits light toward the non-contact area A3 of the intermediate transfer belt 26, and a light receiving portion that receives the light emitted from the light emitting portion and reflected by the non-contact area A3 of the intermediate transfer belt 26. The detection portion 46 inputs an electrical signal corresponding to the density of the toner image to be detected to the control portion 7.

As shown in FIG. 3, the detection portions 46 are located farther on a downstream side in the belt rotation direction D5 than the transfer position of the toner image by the secondary transfer roller 27, and farther on an upstream in the belt rotation direction D5 than a cleaning position on the outer peripheral surface of the intermediate transfer belt 26 by the belt cleaning portion 26C. In addition, the detection portions 46 may be arranged farther on the downstream side in the belt rotation direction D5 than the photoconductor drum 31 of the image forming unit 24, and farther on the upstream side in the belt rotation direction D5 than the transfer position of the toner image by the secondary transfer roller 27.

### Configuration of Control Portion 7

Next, configuration of the control portion 7 will be described with reference to FIG. 2.

As shown in FIG. 2, the control portion 7 includes a first image processing portion 51, a second image processing portion 52, a detection processing portion 53, a count processing portion 54, and an adjustment processing portion 55. More specifically, the ROM 12 of the control portion 7 stores in advance an image forming program for causing the CPU 11 to function as each of the above-mentioned processing portions. The CPU 11, by executing the image forming program stored in the ROM 12, functions as each of the above-mentioned processing portions.

Note that the image forming program may be recorded on a computer-readable recording medium such as a CD, a DVD, or a flash memory, and may be read from the recording medium and stored in a storage device such as the storage portion 6. In addition, some or all of the first image processing portion 51, the second image processing portion 52, the detection processing portion 53, the count processing portion 54, and the adjustment processing portion 55 may be composed of electronic circuits such as an integrated circuit (ASIC).

The first image processing portion 51 executes a print image forming process in which a print image based on image data to be printed, which is included in a printing job to be executed, is formed in a predetermined printing area A1 (see FIG. 4) on the intermediate transfer belt 26 by the image forming portion 3. More specifically, the first image processing portion 51 controls the laser scanning unit 25 based on the image data to form electrostatic latent images corresponding to each color on the photoconductor drum 31 of each image forming unit 20 at a preset timing. In each of the image forming units 20, the electrostatic latent image formed on the photoconductor drum 31 is developed into a toner image, and the toner images are sequentially transferred onto the intermediate transfer belt 26. After that, the color or monochrome print image formed on the intermediate transfer belt 26 is transferred onto the sheet by the secondary transfer roller 27, and the intermediate transfer belt 26 is cleaned by the belt cleaning portion 26C.

Note that in the print image forming process, the first image processing portion 51 controls the amount of light of a laser beam irradiated by the laser scanning unit 25 based on preset input/output characteristics (gamma characteristics) and the image data. In addition, in the print image forming process, the first image processing portion 51 controls the developing bias voltage in each image forming unit 20 to a value that is preset for that image forming unit 20. Furthermore, the first image processing portion 51 controls the charging voltage, the primary transfer current, and the secondary transfer current of the secondary transfer roller 27 in each image forming unit 20 during the print image forming process.

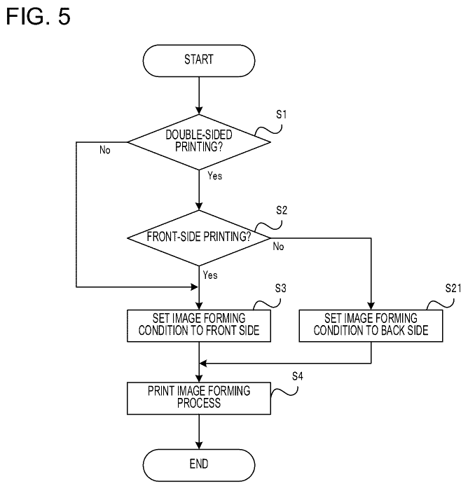

In addition, in the print image forming process, the first image processing portion 51 executes a preset inter-sheet process during an inter-sheet period PO (see FIG. 5) between a process of forming a print image based on one page of image data on the intermediate transfer belt 26 and a process of forming a print image based on the next page of image data on the intermediate transfer belt 26. For example, in the inter-sheet process, cleaning of the photoconductor drum 31 by the drum cleaning portion 35 is executed. In addition, in the inter-sheet process, various types of image processing may be executed on image data corresponding to the next page in the print image forming process.

In addition, the first image processing portion 51 executes a double-sided printing process for controlling the image forming portion 3 and the sheet feed portion 4 in the image forming apparatus 100 to execute the double-sided printing operation. More specifically, in a case of executing the double-sided printing process on a single sheet, the first image processing portion 51 feeds the sheet from the sheet feed cassette to the image forming portion 3 and transfers the print image corresponding to the front side of the sheet onto the front side of the sheet. The first image processing portion 51 causes the sheet to be conveyed again to the image forming portion 3 in a state in which the front and back sides of the sheet is turned over by the double-sided printing mechanism 4A. After that, the first image processing portion 51 causes the image forming portion 3 to transfer a print image corresponding to the back side of the sheet onto the back side of the sheet, and causes the sheet to be discharged onto the sheet discharge tray 29. In particular, in the double-sided printing process, the first image processing portion 51 executes the print image forming process corresponding to the front side and the print image forming process corresponding to the back side under different image forming conditions.

In addition, in a case of performing the double-sided printing process on a plurality of sheets, the first image processing portion 51 changes the execution order of the print image forming process for the print images corresponding to each page on the front and back sides of the plurality of sheets. More specifically, when executing a double-sided printing process on three sheets, the first image processing portion 51 causes the image forming portion 3 to form an image on each page in the order of the front side of the first sheet, the front side of the second sheet, the back side of the first sheet, the front side of the third sheet, the back side of the second sheet, and the back side of the third sheet on the intermediate transfer belt cleaning portion 26.

On the other hand, in a case of executing a double-sided printing process on three sheets, the first image processing portion 51 feeds the first sheet from the paper feed cassette to the image forming portion 3 and transfers the print image corresponding to the front side onto the front side of the first sheet. The first image processing portion 51 then retracts the first sheet to the double-sided printing mechanism 4A of the sheet feed portion 4.

Next, the first image processing portion 51 feeds a second sheet from the sheet feed cassette to the image forming portion 3, and transfers a print image corresponding to the front side of the second sheet onto the front side of the second sheet. The first image processing portion 51 retracts the second sheet to the double-sided printing mechanism 4A, feeds the first sheet from the double-sided printing mechanism 4A to the image forming portion 3, and transfers the printed image corresponding to the back side to the back side of the first sheet. After that, the first image processing portion 51 causes the first sheet to be discharged onto the sheet discharge tray 29.

Similarly, the first image processing portions 51 feeds the third sheet from the sheet feed cassette to the image forming portion 3, and transfers the print image corresponding to the front side of the third sheet onto the front side of the third sheet. The first image processing portion 51 retracts the third sheet to the double-sided printing mechanism 4A, feeds the second sheet from the double-sided printing mechanism 4A to the image forming portion 3, and transfers the printed image corresponding to the back side to the back side of the second sheet. After that, the first image processing portion 51 causes the second sheet to be discharged onto the sheet discharge tray 29.

After that, the first image processing portion 51 feeds the third sheet from the double-sided printing mechanism 4A to the image forming portion 3, and transfers the print image corresponding to the back side onto the back side of the third sheet. After that, the first image processing portion 51 causes the third sheet to be discharged onto the sheet discharge tray 29.

In this way, in the image forming apparatus 100, in a case in which the double-sided printing process is executed on a plurality of sheets, the order of the print image forming process corresponding to the front and back sides of each of the sheets is changed, and conveying control is performed for each of the sheets, thereby shortening the time required for the double-sided printing process. On the other hand, in other embodiments, even in a case in which the double-sided printing process is executed on a plurality of sheets, similar to a case in which the double-sided printing process is executed on one sheet, after the print image forming process corresponding to the front and back sides of one sheet is executed, the print image forming process corresponding to the front and back sides of the next sheet may be executed.

The second image processing portion 52 executes a detection image forming process when a preset execution condition is satisfied. In the detection image forming process, detection toner images X10 (an example of a detection image) used to adjust the image forming condition in the image forming portion 3 are formed by the image forming portion 3 in the non-contact areas A3 (see FIG. 4) outside the printing area A1 (see FIG. 4) on the intermediate transfer belt 26. The print area A1 is an area on the outer peripheral surface of the intermediate transfer belt 26 inside a contact area A2 (see FIG. 4). For example, the print area A1 is a contact area on the outer peripheral surface of the intermediate transfer belt 26 that comes in contact with a sheet having a maximum size that can be used in the image forming apparatus 100. Note that the printing area A1 and the contact area A2 may be the same area.

In the present embodiment, the detection toner images X10 are formed in the non-contact areas A3 (see FIG. 4), and thus compared to a configuration in which the detection toner image X10 is formed in the contact area A2, it is possible to simplify the configuration by eliminating the need to provide a cleaning portion that removes the detection toner image X10 adhering to the secondary transfer roller 27 from the secondary transfer roller 27. On the other hand, the detection toner images X10 may be formed in an area outside the printing area A1 (see FIG. 4) and inside the contact area A2 (see FIG. 4). However, in this case, the detection portions 46 are arranged farther on the downstream side in the belt rotation direction D5 than the photoconductor drum 31 of the image forming unit 24 and farther on the upstream side in the belt rotation direction D5 than the transfer position of the toner image by the secondary transfer roller 27.

In addition, the second image processing portion 52, based on predetermined detection image data corresponding to each color, forms detection toner images X10 on the intermediate transfer belt 26, the detection toner images X10 including detection toner images corresponding to the plurality of colors corresponding to the plurality of image forming units 20. For example, the detection toner images X10 are a plurality of rectangular images formed at preset densities or positions different from one another.

In the present embodiment, the execution condition is that a cumulative number of printed sheets in the image forming apparatus 100 reaches a predetermined first reference number of sheets. For example, the first reference number of sheets is 100 or 200 sheets. In addition, the execution condition may be that the number of printed sheets during execution of one printing job reaches a predetermined second reference number of sheets. Moreover, the execution condition may be the passage of a predetermined specific time.

The detection processing portion 53 detects the density and position of the detection toner images X10 formed in the non-contact areas A3 of the intermediate transfer belt 26 using each of the detection portions 46. Note that the detection processing portion 53 may only detect either the density or the position of the detection toner images X10. For example, in a case in which only a density correction process is executed in the adjustment process described below, it is sufficient to detect the density of the detection toner images X10, and in a case in which only a position deviation correction process is performed in the adjustment process described below, it is sufficient to detect the positions of the detection toner images X10.

The count processing portion 54 executes a counting process for counting the cumulative number of printed sheets in the image forming apparatus 100. The cumulative number of printed sheets counted in the counting process is used to determine timing for executing the adjustment process by the adjustment processing portion 55. For example, the count processing portion 54 resets a count value to 0 every time the adjustment process is executed in the image forming apparatus 100. Note that the count processing portion 54 may count the cumulative number of printed sheets for each printing type, such as color and monochrome.

The adjustment processing portion 55 executes an adjustment process for adjusting the image forming condition based on the detection result by the detection processing portion 53. More specifically, the adjustment processing portion 55 executes the density correction process, position deviation correction process, and the like in the adjustment process.

In the density correction process, in a case in which a difference between the density of the detection toner images X10 detected by the detection processing portion 53 and a predetermined reference density is less than a predetermined threshold value, the amount of light emitted by the laser scanning unit 25 is adjusted as the image forming condition based on the difference. In addition, in the density correction process, in a case in which the difference between the density of the detection toner images X10 detected by the detection processing portion 53 and the reference density is equal to or greater than the threshold value, the developing bias voltage is adjusted as the image forming condition based on the difference. For example, the reference density is the density of the detection toner images X10 that was detected during the immediately preceding adjustment of the image forming conditions. Note that the image forming conditions adjusted in the density correction process are not limited to the amount of light emitted by the laser scanning unit 25 and the developing bias voltage. For example, the image forming condition may include the input/output characteristics, the charging voltage, the primary transfer current, and the secondary transfer current.

In the position deviation correction process, the image formation timing (light irradiation timing by the laser scanning unit 25) by the image forming units 20 of each color is adjusted based on the difference between the detection positions of the detection toner images X10 detected by the detection processing portion 53 and a predetermined specific position.

In the image forming apparatus 100, the double-sided printing process may be executed in which images are printed on both sides of a sheet. In addition, in the double-sided printing process, the image forming condition such as the primary transfer current or the developing bias voltage in the image forming portion 3 may differ between printing on the front side and printing on the back side. Therefore, when the image forming condition in the image forming portion 3 is adjusted based on the density or position of the detection toner images formed in the detection image forming process corresponding to both the front and back sides, an effect obtained by adjusting the image forming condition may be reduced. On the other hand, as will be described below, in the image forming apparatus 100 according to the present embodiment, it is possible to enhance the effect obtained by adjusting the image forming condition executed when the double-sided printing process is executed.

### Printing Control Process

The control portion 7 executes the printing control process every time the print image forming process based on one page of image data to be printed, which is included in the printing job to be executed, is started. Here, an example of a procedure of a printing control process executed by the control portion 7 in the image forming apparatus 100 will be described with reference to FIG. 5. Note that steps S1, S2, . . . represent numbers of processing procedures (steps) executed by the control portion 7.

### Step S1

In step S1, the first image processing portion 51 of the control portion 7 determines, based on contents of the printing job to be executed in the image forming apparatus 100, whether or not the print image forming process executed based on the printing job is a double-sided printing process. The contents of the printing job are set by an information processing apparatus (not shown) that inputs image data to the image forming apparatus 100, or by a user operation on the operation display portion 5 of the image forming apparatus 100. When it is determined that the print image forming process executed based on the printing job is a double-sided printing process (S1: Yes), the process proceeds to step S2, and when it is determined that the print image forming process is not a double-sided printing process (S1: No), the process proceeds to step S3.

### Step S2

In step S2, the first image processing portion 51 of the control portion 7 determines whether or not the print image forming process to be executed is a front side printing process for forming an image on the front side of a sheet. When it is determined that the print image forming process to be executed is a front side printing process (S2: Yes), the process proceeds to step S3, and when it is determined that the print image forming process is not a front side printing process (S2: No), the process proceeds to step S21.

### Step S3

In step S3, the first image processing portion 51 of the control portion 7 sets the image forming condition in the print image forming process executed in step S4 described later to a predetermined front side image forming condition. More specifically, the front side image forming condition includes various types of set values such as the primary transfer current or the developing bias voltage.

### Step S21

In step S21, the first image processing portion 51 of the control portion 7 sets the image forming condition in the print image forming process executed in step S4 described later to a predetermined back side image forming condition. More specifically, in the back side image forming condition, the primary transfer current, the developing bias voltage, or the like are set to values lower than those in the front side image forming condition. Thus, the toner is prevented from being charged up in the image forming portion 3.

### Step S4

In step S4, the first image processing portion 51 of the control portion 7 executes a printing process including the print image forming process according to the image forming condition set in step S3 or step S21.

### Adjustment Control Process

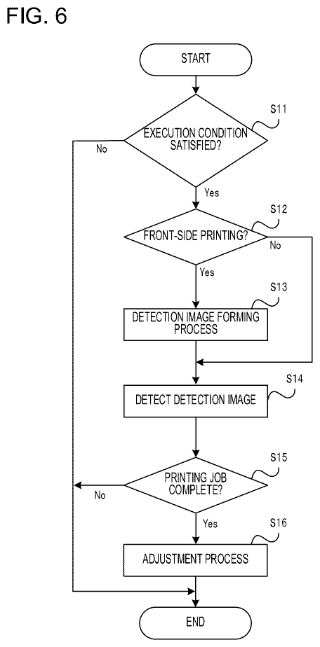

In addition, the control portion 7 executes the adjustment control process every time the print image forming process based on image data for one page to be printed, which is included in the printing job to be executed, is started. Here, an example of a procedure of the adjustment control process executed by the control portion 7 in the image forming apparatus 100 will be described with reference to FIG. 6. Note that steps S11, S12, . . . represent numbers of processing procedures (steps) executed by the control portion 7.

### Step S11

In step S11, the second image processing portion 52 of the control portion 7 determines whether or not the execution condition is satisfied. When it is determined that the execution condition is satisfied (S11: Yes), the process proceeds to step S12, and when the execution condition is not satisfied (S11: No), the adjustment control process ends.

### Step S12

In step S12, the second image processing portion 52 of the control portion 7 determines whether or not the print image forming process to be executed is the front side printing process. Here, when it is determined that the print image forming process to be executed is the front side printing process (S12: Yes), the process proceeds to step S13, and when it is determined that the print image forming process to be executed is not the front side printing process (S12: No), the process proceeds to step S14.

### Step S13

In step S13, the second image processing portion 52 of the control portion 7 executes the detection image forming process. That is, the second image processing portion 52 executes the detection image forming process based on the detection image data corresponding to the detection toner images X10 only while the first image processing portion 51 is executing the front side printing process. Thus, as shown in FIG. 5, in the image forming portion 3, a printed image based on the image data is formed in the printing area A1 of the intermediate transfer belt 26, and detection toner images X10 based on the detection image data is formed in the non-contact areas A3 of the intermediate transfer belt 26. Note that the second image processing portion 52 does not form the detection toner images X10 on the intermediate transfer belt 26 while the inter-sheet process is being executed (S12: Yes).

That is, in a case in which the printing job to be executed is a double-sided printing process, and of the double-sided printing process, a printing process for the back side of the sheet (hereinafter referred to as “back side printing process”) is executed, the second image processing portion 52 of the control portion 7 does not execute the detection image forming process even when the execution condition is satisfied. Therefore, in the image forming apparatus 100, the detection toner images X10 formed by the detection image forming process are formed under the image forming condition (front image forming condition) when the front side printing process is executed to form a printed image on the front side of the sheet in the double-sided printing process.

Note that as another embodiment, in a case in which the printing job to be executed is a double-sided printing process and of the double-sided printing process the front side printing process is executed, the detection image forming process is not executed, and in a case in which the back side printing process is executed, the detection image forming process is executed. That is, in a case in which the second image processing portion 52 executes the detection image forming process during execution of a double-sided printing job in which the print image is formed on both the front and back sides of a sheet, the detection image forming process only needs to be executed under the image forming condition in the print image forming process that correspond to a predetermined one of the front and back sides.

### Step S14

In step S14, the detection processing portion 53 of the control portion 7 detects the density and position of the detection toner images X10 formed on the intermediate transfer belt 26 in step S13 using the detection portions 46, and stores the detected density and position in the storage portion 6. Here, the density and position of the detected detection toner images X10 are used in the adjustment process of the image forming conditions in step S16 described later.

### Step S15

In step S15, the second image processing portion 52 of the control portion 7 determines whether or not the printing job to be executed has been completed. More specifically, the second image processing portion 52 of the control portion 7 determines that the printing job is completed when the printing image for the last page in the printing job is formed on the intermediate transfer belt 26. When it is determined that the printing job has been completed (S15: Yes), the process proceeds to step S16, and when it is determined that the printing job has not been completed (S15: No), the adjustment control process ends.

### Step S16

In step S16, the second image processing portion 52 of the control portion 7 executes the adjustment process based on the detection result of the detection toner images X10 by the detection portions 46. Thus, in the print image forming process executed after execution of step S16, the adjustment contents of the image forming conditions by the adjustment process in step S16 are reflected. In addition, in step S16, the second image processing portion 52 resets to zero the cumulative number of printed sheets for determining whether the execution condition is satisfied. Thus, each time the cumulative number of printed sheets reaches the first reference number of sheets, it is determined that the execution condition is satisfied, and the adjustment process is executed.

Note that in the present embodiment, a case in which the adjustment process is executed in step S16 is described as an example; however, the adjustment process may be executed at any timing after the density and position of each detection toner image X10 has been detected in step S14. For example, some or all of the adjustment process may be executed between step S14 and step S15.

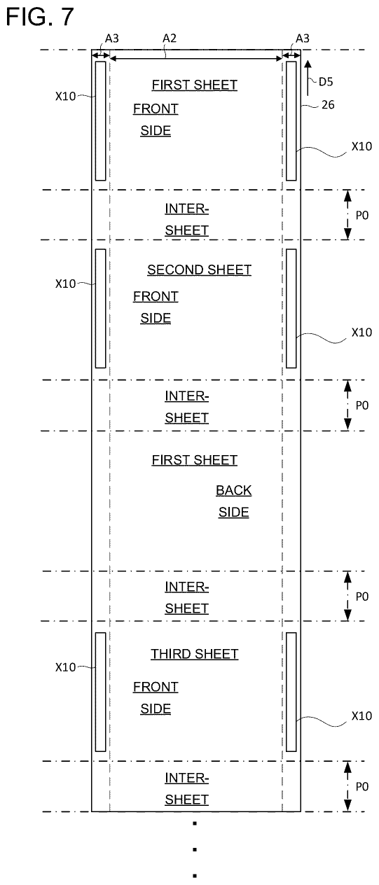

Here, FIG. 7 is a diagram schematically showing an example of an execution result of the adjustment control process according to the present embodiment. FIG. 7 shows a part of the execution result of the adjustment control process in a case in which the content of the printing job is a double-sided printing process for three sheets and the execution condition of the adjustment process is satisfied.

More specifically, as shown in FIG. 7, when the print image forming process is executed based on image data corresponding to the front side of the first sheet, the detection image forming process is executed together with the print image forming process. Thus, in the area on the intermediate transfer belt 26 corresponding to the front side of the first sheet, a print image based on the image data is formed in the printing area A1 inside the contact area A2, and detection toner images X10 are formed in the non-contact areas A3.

Next, after the print image forming process based on image data corresponding to the front side of the first sheet is completed and the inter-sheet period PO has elapsed, the print image forming process is then executed based on image data corresponding to the front side of the second sheet. Here also, when the print image forming process is executed based on image data corresponding to the front side of the second sheet, the detection image forming process is executed together with the print image forming process. Thus, in the area on the intermediate transfer belt 26 corresponding to the front side of the second sheet, a print image based on the image data is formed in the printing area A1 inside the contact area A2, and detection toner images X10 are formed in the non-contact areas A3.

Next, after the print image forming process based on image data corresponding to the front side of the second sheet is completed and the inter-sheet period PO has elapsed, the print image forming process is then executed based on image data corresponding to the back side of the first sheet. Here, when the print image forming process is executed based on image data corresponding to the back side of the first sheet, the detection image forming process is not executed. Thus, as shown in FIG. 7, in the area on the intermediate transfer belt 26 corresponding to the back side of the first sheet, a print image based on the image data is formed in the contact area A2; however, detection toner images X10 are not formed in the non-contact areas A3.

After that, similarly, after the print image forming process based on image data corresponding to the back side of the first sheet is completed and the inter-sheet period PO has elapsed, the print image forming process is then executed based on image data corresponding to the front side of the third sheet. Here, when the print image forming process is executed based on image data corresponding to the front side of the third sheet, the detection image forming process is executed. Thus, in the area on the intermediate transfer belt 26 corresponding to the front side of the third sheet, a print image based on the image data is formed in the printing area A1 inside the contact area A2, and detection toner images X10 are formed in the non-contact areas A3.

Note that after the print image forming process based on the image data corresponding to the front side of the third sheet is completed and the inter-sheet period PO has elapsed, the print image forming process is then executed based on the image data corresponding to the back side of the second sheet. Here also, when the print image forming process is executed based on image data corresponding to the back side of the second sheet, the detection image forming process is not executed.

After that, when the print image forming process based on image data corresponding to the back side of the second sheet is completed and the inter-sheet period PO has elapsed, the print image forming process is then executed based on image data corresponding to the back side of the third sheet. Here also, when the print image forming process is executed based on image data corresponding to the back side of the third sheet, the detection image forming process is not executed.

As described above, in the image forming apparatus 100 according to the present embodiment, the detection toner images X10 are subjected to the detection image forming process simultaneously with the front side printing process, and the detection image forming process is not performed when the back side printing process is executed. In the image forming apparatus 100, the adjustment process is executed based on the detection result of the detection toner images X10 formed in the detection image forming process that is executed simultaneously with the front side printing process. Thus, the adjustment process is executed based on the detection result of the detection toner images X10 formed under the same image forming condition. Therefore, in the image forming apparatus 100, the effect of the adjustment process is enhanced compared to a case in which the adjustment process is executed based on the detection results of the detection toner images X10 that are formed in both the front side printing process and the back side printing process, which have different image forming conditions.

### Other Embodiments

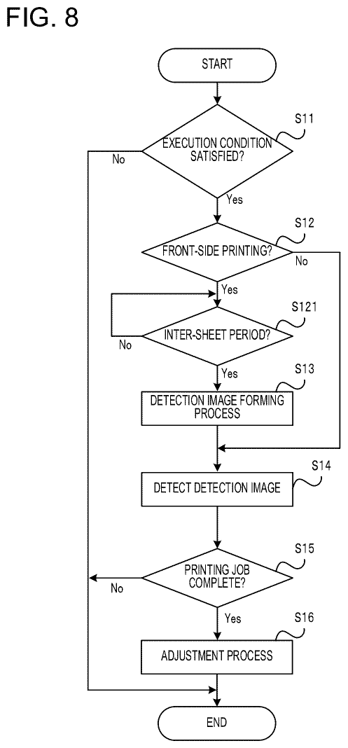

In the above embodiment, a case has been described in which the detection image forming process is executed simultaneously with the print image forming process. On the other hand, in another embodiment, executing the detection image forming process during the inter-sheet period PO is considered. Here, FIG. 8 is a diagram showing another example of the adjustment control process. Note that in the adjustment control processes shown in FIG. 8, the same processes as those in the adjustment control process described in the above embodiment (see FIG. 6) are denoted by the same reference numerals, and a description thereof will be omitted.

### Step S121

As shown in FIG. 8, in step S12 of the present embodiment, when it is determined that the print image forming process to be executed is the front side printing process (S12: Yes), the process proceeds to step S121. In step S121, the second image processing portion 52 of the control portion 7 determines whether or not the inter-sheet period PO has arrived.

For example, the second image processing portion 52 can determine that the inter-sheet period PO has arrived after irradiation of a laser beam from the laser scanning unit 25 based on one page of image data included in the printing job has begun and the irradiation of a laser beam based on the image data has ended. In addition, the second image processing portion 52 may determine that the inter-sheet period PO has arrived when a preset time has elapsed since the start of irradiation of a laser beam from the laser scanning unit 25 based on one page of image data included in the printing job.

When it is determined that the inter-sheet period PO has arrived (S121: Yes), the process proceeds to step S13, and the process waits in step S121 until the inter-sheet period PO arrives (S121: No). In the present embodiment, in step S13, the detection image forming process is executed during the inter-sheet period PO.

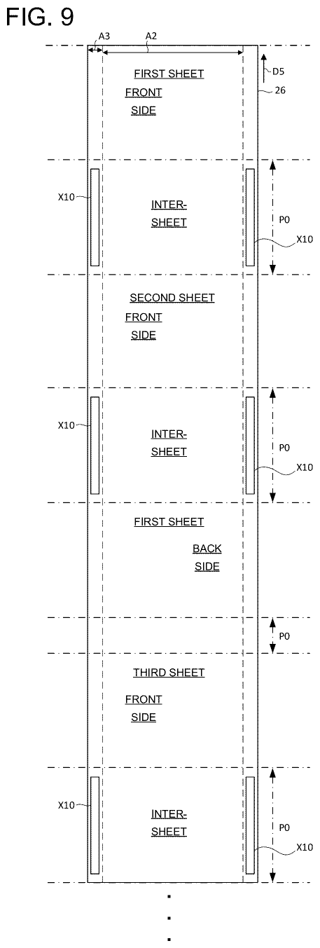

Here, FIG. 9 is a diagram schematically showing an example of an execution result of the adjustment control process (see FIG. 8) according to the present embodiment. FIG. 9 shows a part of the execution result of the adjustment control process in a case in which the content of the printing job is a double-sided printing process for three sheets and the execution condition of the adjustment process is satisfied.

More specifically, as shown in FIG. 9, when the print image forming process is executed based on image data corresponding to the front side of the first sheet, the detection image forming process is executed in the inter-paper period PO after the print image forming process is executed. Thus, detection toner images X10 are formed in the non-contact areas A3 on the intermediate transfer belt 26 corresponding to the inter-sheet period PO after the print image forming process that corresponds to the front side of the first sheet.

Next, when the inter-sheet period PO has elapsed after the end of the print image forming process corresponding to the front side of the first sheet, the print image forming process is executed based on the image data corresponding to the front side of the second sheet. Here also, when the print image forming process is executed based on image data corresponding to the front side of the second sheet, the detection image forming process is also executed during the inter-sheet period PO after the print image forming process is executed. Thus, detection toner images X10 are formed in the non-contact areas A3 on the intermediate transfer belt 26 corresponding to the inter-sheet period PO after the print image forming process that corresponds to the front side of the second sheet.

Next, when the inter-sheet period PO has elapsed after the print image forming process corresponding to the front side of the second sheet is completed, the print image forming process is then executed based on image data corresponding to the back side of the first sheet. Here, the detection image forming process is not executed during the inter-sheet period PO after the print image forming process is executed based on image data corresponding to the back side of the first sheet. Thus, as shown in FIG. 9, detection toner images X10 are not formed in the non-contact areas A3 on the intermediate transfer belt 26 corresponding to the inter-sheet period PO after the print image forming process that corresponds to the back side of the first sheet.

Similarly, after the inter-sheet period PO has elapsed since the end of the print image forming process corresponding to the back side of the first sheet, the print image forming process is then executed based on image data corresponding to the front side of the third sheet. Here also, when the print image forming process is executed based on image data corresponding to the front side of the third sheet, the detection image forming process is also executed during the inter-sheet period PO after the print image forming process is executed. Thus, detection toner images X10 are formed in the non-contact areas A3 on the intermediate transfer belt 26 corresponding to the inter-sheet period PO after the print image forming process that corresponds to the front side of the third sheet.

Note that when the inter-sheet period PO has elapsed after the print image forming process corresponding to the front side of the third sheet is completed, the print image forming process is then executed based on image data corresponding to the back side of the second sheet. Here, the detection image forming process is not executed during the inter-sheet period PO after the print image forming process is executed based on image data corresponding to the back side of the second sheet.

After that, when the inter-sheet period PO after completion of the print image forming process corresponding to the back side of the second sheet has elapsed, the print image forming process is then executed based on image data corresponding to the back side of the third sheet. Here, the detection image forming process is not executed during the inter-sheet period PO after the print image forming process is executed based on image data corresponding to the back side of the third sheet.

As described above, in the image forming apparatus 100 according to the present embodiment, the detection image forming process for the detection toner images X10 is executed in the inter-sheet period PO after the front side printing process is completed, and the detection image forming process is not executed in the inter-sheet period PO after the back side printing process is completed. In the image forming apparatus 100, the adjustment process is executed based on the detection result of the detection toner images X10 formed in the detection image forming process that is executed during the inter-sheet period PO after the front side printing process is completed. Thus, the adjustment process is executed based on the detection result of the detection toner images X10 formed under the same image forming condition. Therefore, in the image forming apparatus 100, the effect of the adjustment process is enhanced compared to a case in which the adjustment process is executed based on the detection results of the detection toner images X10 that are formed during the inter-sheet periods PO after both the front side printing process and the back side printing process, which have different image formation conditions. In addition, in the image forming apparatus 100 of the present embodiment, after the detection toner images X10 are detected in step S14, the adjustment process based on the detection result of the detection toner images X10 may be executed as the inter-sheet process during the inter-sheet period PO.

Note that in another embodiment, in the image forming apparatus 100, the control portion 7 may automatically switch the content of the detection image forming process executed when the double-sided printing process is executed. For example, the control portion 7 may be capable of switching the operation mode of the image forming apparatus 100 between a first operating mode and a second operating mode. The first operating mode is an operating mode in which printing speed is prioritized over image quality of printing in the image forming apparatus 100, and the second operating mode is an operating mode in which printing image quality is prioritized over printing speed in the image forming apparatus 100. In a case in which the double-sided printing process is being executed and the first operating mode is being executed, the second image processing portion 52 executes the detection image forming process in a first detection mode in which the detection image forming process is executed simultaneously with the front side printing process. In addition, in a case in which the double-sided printing process is being executed and the first operating mode is being executed, the second image processing portion 52 executes the detection image forming process in a second detection mode in which the detection image forming process is executed in the inter-sheet period PO after the front side printing process is executed. That is, the second image processing portion 52 may be capable of switching between the first detection mode and the second detection mode.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image forming portion configured to form an image on a transfer medium based on input image data and transfer the image from the transfer medium to a sheet;
a first image processing portion configured to execute a print image forming process in which the image forming portion forms a print image in a predetermined print area on the transfer medium based on image data of a printing target; and
a second image processing portion configured to, when a preset execution condition is satisfied, execute a detection image forming process in which a detection image used for adjusting an image forming condition in the image forming portion is formed in an area outside the printing area on the transfer medium by the image forming portion; wherein
in a double-sided printing process that forms the print image on a front side and a back side of a sheet, the first image processing portion executes the print image forming process corresponding to the front side and the print image forming process corresponding to the back side under different image forming conditions; and
in a case in which the detection image forming process is executed during execution of the double-sided printing process, the second image processing portion executes the detection image forming process only under the image forming conditions in the print image forming process corresponding to a predetermined one of the front side and the back side.

2. The image forming apparatus according to claim 1, wherein the second image processing portion executes the detection image forming process only during execution of the print image forming process corresponding to the one side in the double-sided printing process.

3. The image forming apparatus according to claim 1, wherein the second image processing portion executes the detection image forming process only during an inter-sheet period from when the print image forming process corresponding to one side in the double-sided printing process ends to when the print image forming process corresponding to a next page is executed.

4. The image forming apparatus according to claim 1, wherein
the second image processing portion is capable of switching between
a mode in which the detection image forming process is executed only while the print image forming process corresponding to one side in the double-sided printing process is being executed, and a mode in which the detection image forming process is executed only during the inter-sheet period from when the print image forming process corresponding to one side in the double-sided printing process ends to when the print image forming process corresponding to a next page is executed.

5. An image forming method comprising
a processor for an image forming apparatus including an image forming portion that forms an image on a transfer medium based on input image data and transfers the image from the transfer medium to a sheet executing
a first step of executing a print image forming process in which the image forming portion forms a print image in a predetermined print area on the transfer medium based on image data of a printing target; and
a second step of, when a preset execution condition is satisfied, executing a detection image forming process in which a detection image used for adjusting an image forming condition in the image forming portion is formed in an area outside the printing area on the transfer medium by the image forming portion; wherein
in a double-sided printing process that forms the print image on a front side and a back side of a sheet, the first step executes the print image forming process corresponding to the front side and the print image forming process corresponding to the back side under different image forming conditions; and
in a case in which the detection image forming process is executed during execution of the double-sided printing process, the second step executes the detection image forming process only under the image forming conditions in the print image forming process corresponding to a predetermined one of the front side and the back side.
